(19) United States
(12) Patent Application Publication
(10) Pub. No.: US 2017/0223071 A1
(43) Pub. Date: Aug. 3, 2017

(54) CONNECTING A DEVICE TO A MEETING

(71) Applicant: MICROSOFT TECHNOLOGY LICENSING, LLC, Redmond, WA (US)

(72) Inventors: Giridhar Kalpathy Narayanan, Bellevue, WA (US); Puja Gomber, Bellevue, WA (US); Deepak Rao, Bellevue, WA (US); Annika Elias, Redmond, WA (US); Sundar Anantharaman, Redmond, WA (US); Nishant Choudhary, Redmond, WA (US)

(73) Assignee: MICROSOFT TECHNOLOGY LICENSING, LLC, Redmond, WA (US)

(21) Appl. No.: 15/486,050

(22) Filed: Apr. 12, 2017

Related U.S. Application Data
(63) Continuation of application No. 13/184,090, filed on Jul. 15, 2011.

(51) Int. Cl. H04L 29/06; H04L 12/18

(52) U.S. Cl. CPC H04L 65/403; H04L 12/1818; G06Q 10/109

(57) ABSTRACT

One or more techniques and/or systems are disclosed for joining a device to a meeting. A device can send a request to join the meeting, such as by selecting a meeting request link in an invitation received at the device. A join meeting service may receive the request, authenticate the request, and return a code package and meeting related document. The code package can be used at the device, and/or at the join meeting service, to identify one or more meeting clients (e.g., applications) on the device. A supported meeting client that may be used to join the device to the meeting can be selected from the one or more meeting identified clients, if at least one meeting client is identified, and launched to join the device to the online meeting.

### RELATED APPLICATIONS

This patent application is a continuation of U.S. patent application Ser. No. 13/184,090, filed Jul. 15, 2011, and entitled “CONNECTING A DEVICE TO A MEETING,” of which is incorporated herein by reference in its entirety.

### BACKGROUND

In a computing environment, users may hold a meeting using a plurality of computing devices networked together (e.g., over the Internet). Commonly, users can select an online location (e.g., comprising a meeting website) for their meeting, and respective invitees may navigate to the online location. Typically, a meeting coordinator can send out invitations to those they wish to participate in the meeting, where the invitations comprise pertinent meeting related information (e.g., times, length, participants, etc.), and a link or other information needed to join the meeting (e.g., URL, phone number, security code). Further, for example, the respective users can authenticate themselves with an application (e.g., online or client-side) in order to join and participate in the online meeting. Some meetings may allow for audio, video, and/or live on-screen interaction, which may be provided by an online-based meeting application, and/or a client-side application on the user's device.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Meetings between people have traditionally been face to face or a telephonic conversation between participants that may be in a same or different geographical location. However, many meetings are “Online Meetings” that are beyond merely audio, and have many different modalities of communication involved, becoming complicated to create, join and manage. A traditional dial-in experience of joining a meeting has been changing for online meetings. Many options for joining and/or participating in online meetings have been used, including use of Protocol handlers, links, etc. As an example, a simple HTTP link has become a common way to specifying meeting coordinates, as client devices typically comprise an installed Browser that can be used to activate such a link. However providing a desired user experience for joining an online meeting when the user clicks on a link is lacking.

Accordingly, one or more techniques and/or systems are disclosed for joining a user's device to an online meeting, in at least an improved and/or simplified manner. When the user selects a link provided in a meeting invitation, applications that could be used to join the device to the meeting may be identified. From identified meeting applications, an appropriate application can be selected and used to join the meeting. The selected application may be automatically launched, and the user can be joined to the meeting using the launched application.

In one embodiment of joining a device to a meeting, a request from the device to join the meeting may be received, where the request can be activated by selection of a meeting request link received by the device. One or more meeting clients (e.g., applications, software, programs, etc.) can be identified on the device. Additionally, a supported meeting client that can be used to join the device to the meeting can be selected from one or more meeting identified clients, if at least one meeting client is identified.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method for joining a device to a meeting.

FIG. 2 is a flow diagram illustrating an example embodiment where one or more portions of one or more techniques described herein can be implemented.

FIG. 3 is a flow diagram illustrating an example embodiment where one or more portions of one or more techniques described herein can be implemented.

FIG. 4 is a diagram illustrating an example embodiment where one or more portions of one or more techniques described herein may be implemented.

FIG. 5 is a flow diagram illustrating another exemplary method for joining a device to a meeting.

FIG. 6 is a flow diagram illustrating an example embodiment where one or more portions of one or more techniques described herein may be implemented.

FIG. 7 is an illustration of an exemplary computer-readable medium comprising processor-executable instructions configured to embody one or more of the provisions set forth herein.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

As provided herein, a method may be devised that provides for selecting an appropriate client application for joining an online meeting. For example, if a user's device does not have the right software, and/or right version of software installed the user may not be able to join a meeting indicated in a meeting invitation. When the user, in this example, clicks on a link in the meeting invitation, even if an application launches, the device may not be connected to the meeting without appropriate client software. A method may utilize a meeting join manager service to identify and select a supported meeting client on the device to join the meeting, for example, and if no supported meeting client is found, direct the device to an online-based meeting client that allows the user to join the meeting.

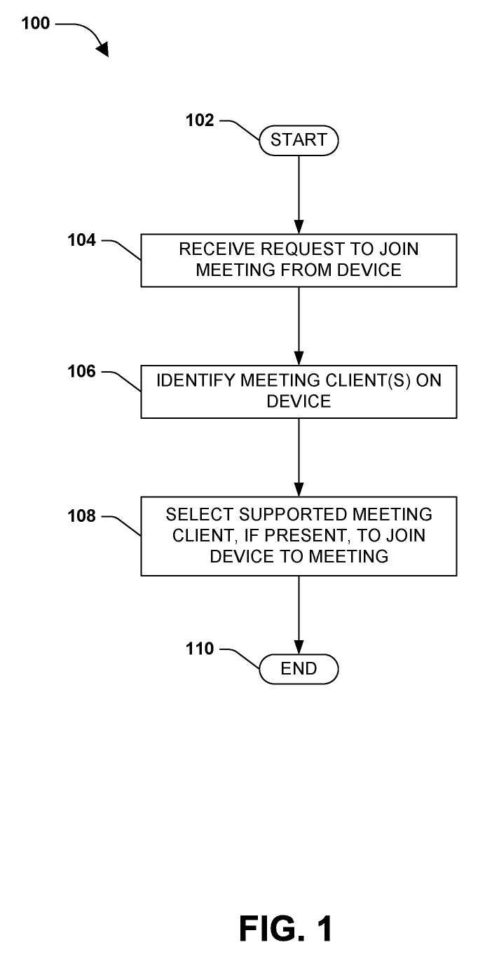

FIG. 1 is a flow diagram illustrating an exemplary method 100 for joining a device to a meeting. The exemplary method 100 begins at 102 and involves receiving a request from the device to join the meeting, where the request is activated by a selection of a meeting request link received by the device (e.g., by a user of the device clicking on the link). It may be appreciated that while a link (and/or a user activating/clicking thereon) is mentioned herein, the instant application, including the scope of the appended claims, is not meant to be so limited. That is, more than merely a link is contemplated (e.g., interactive icon, item within a calendar, user interface, and/or voice recognized/activated command, etc. in addition to and/or alternative to a link). Any and/or all of such manners of requesting to join a device to a meeting are contemplated herein and are intended to fall within the scope of the appended claims. At 106, one or meeting clients (e.g., applications, software, programs, etc.) can be identified on the device. For example, the device may comprise one or more client applications, and/or one or more versions of a client application, that may be used to join a meeting.

At 108, a supported meeting client is selected for joining the device to the meeting from the one or more meeting clients identified on the device. The supported meeting client is selected if at least one meeting client is identified on the device. For example, the joining of the device to the meeting (e.g., and/or continued operation of an online meeting) may utilize particular computing parameters that may or may not be properly supported by respective identified meeting clients. Further, as an example, a first identified meeting client may comprise a desired configuration over a second identified meeting client, such as to provide a better user experience (e.g., a newer version may provide enhancements over an older version). In one embodiment, the identified meeting client that supports joining of the device to the meeting (e.g., and/or continued meeting operations), and/or provides a desired meeting experience can be selected as the supported meeting client from the one or more identified meeting clients.

Having selected the supported meeting client, the exemplary method 100 ends at 110.

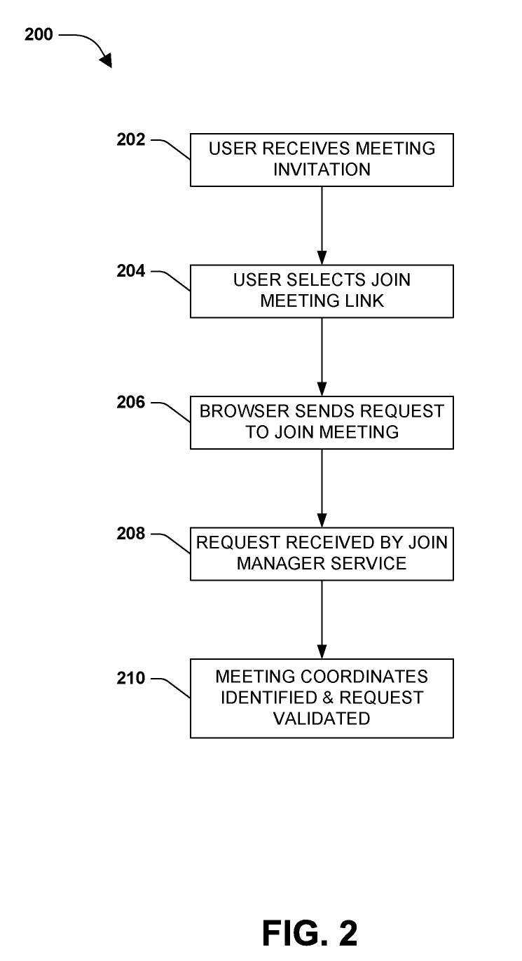

FIG. 2 is a flow diagram illustrating an example embodiment 200 where one or more portions of one or more techniques described herein may be implemented. At 202, a user receives a meeting invitation on a device. For example, a contact of the user may set up an online meeting (e.g., using the Internet, or some other network) and send a message to the user (e.g., email, instant message, text, etc.) that comprises the meeting invitation. Typically, meeting invitations comprise a link that may activate joining the user's device to the meeting. In one embodiment, the link can comprise a uniform resource identifier (URI), such as a uniform resource locator (URL), which may identify a location on a network (e.g., a web address) for activating, joining, and/or operating the online meeting. For example the “join meeting” link may comprise a hypertext transfer protocol (HTTP) link that comprises coordinates on the Internet for joining, and/or participating in the meeting.

At 204, the user selects a “join meeting” link in the meeting invitation. For example, the user may review details of the meeting (e.g., when, length, subject, attendees, etc.) and can select the link by clicking on it with a mouse driven pointer, and/or activating the link using some other input device. In one embodiment, when the link is selected (e.g., activated) a browser on the device can be launched (e.g., if not already launched), and the browser can send a request to join the meeting, at 206.

As an example, a device's default browser may comprise a default handler of HTTP links, and when the link in the meeting invitation is selected the default HTTP handler is launched. Further, in this example, upon launching, the browser can send an HTTP request, to join the meeting, to the URL that is comprised in the link. At 208, the request can be received by a join manager service. As an example, the join manager service may be deployed to handle meeting join requests. In this example, the join manager service can receive respective incoming requests for a device to join a meeting, and direct the device to an appropriate location on the network for joining/participating in the meeting.

At 210, meeting coordinates from the meeting request link can be identified, and the request to join the meeting can be validated. As an example, the join manager service can identify meeting coordinates for the meeting from data in the HTTP link, where the meeting coordinates can identify an online location of the meeting. Further, validating can comprise identifying that the device requesting to join the meeting comprises an authorized device, and/or that the meeting is scheduled to occur at a desired time indicated by the request. For example, the join manager service can perform a potential data base lookup to a meeting repository to validate the requesting device, and/or to determine that the meeting is occurring at the time of the request.

Additionally, validating can comprise identifying whether the request is intended to be handled by a second join manager where the request is received by a first join manager. For example, the join manager service that receives the request, the first join manger, may identify that the request is supposed to be handled by another join manager, the second join manager. In one embodiment, the first join manager can identify the second join manager and forward the request to the second join manager. For example, if the first join manager is not the right service to process the request the first join manager can perform an HTTP 302 response that redirects the request to the correct service (e.g., the second join manger).

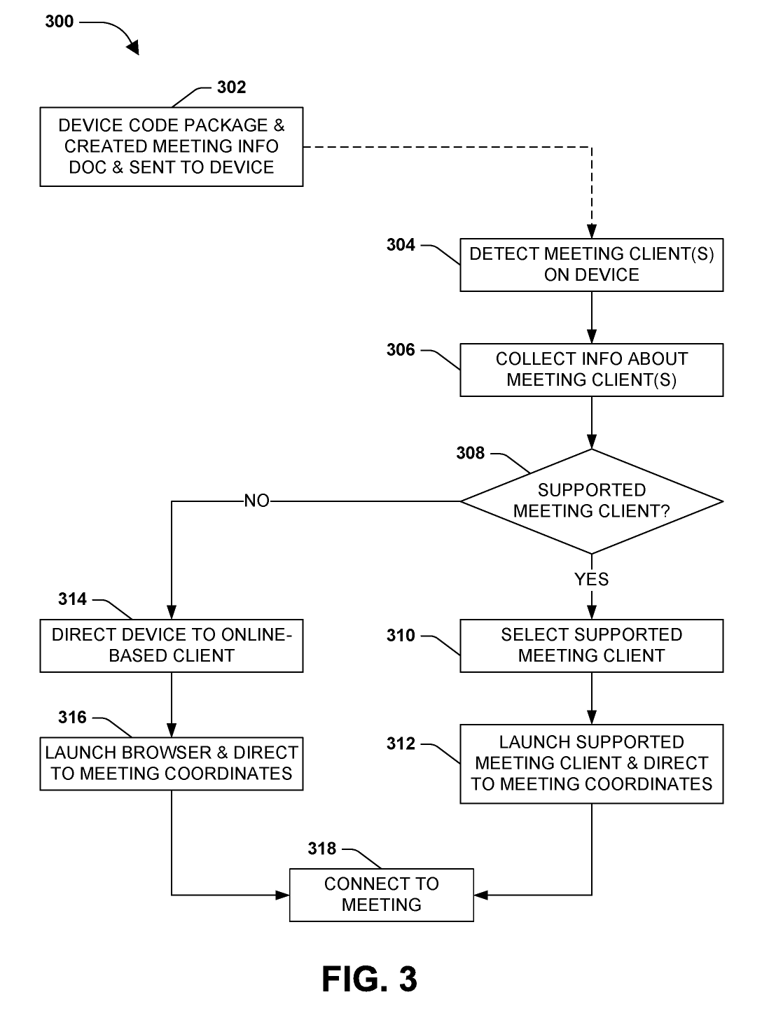

FIG. 3 is a flow diagram illustrating an example embodiment 300 where one or more portions of one or more techniques described herein can be implemented. At 302, in one embodiment, a device code package and/or a document comprising meeting related information can be sent to a device requesting to join a meeting, for example in response to the request (e.g., request to join the device to the meeting). As an example, the device code package can comprise script comprising logic for performing checks at the device side, to select an appropriate application used to join the meeting. In one embodiment, the code package can comprise code (e.g., script code) that is configured to identify one or more meeting clients on the device; select a supported meeting client from the one or more identified meeting clients; launch the supported meeting client; and/or direct the device to an online-based meeting client if the supported meeting client is not selected (e.g., no meeting clients are identified, and/or no supported meeting client is identified). It may be appreciated that the code may facilitate any one or more or the foregoing, such as by working with additional, applications, programming, code, etc. on the device, for example.

Further, as an example, a join manager service may create (e.g., on-the-fly in response to the join meeting request) the document whose contents comprise information needed by a device side application to join the meeting successfully. In one embodiment, the created document can comprise the online meeting coordinates that are used to join the meeting; and/or meeting validation information, for example, that can be used to validate the device for the meeting. In one embodiment, the combined device code package and document can be sent back to the device as part of the code (e.g., XML script), for example, in an HTTP response to the request.

At 304 in the example embodiment 300, one or more meeting clients (e.g., applications) can be identified (e.g., detected) on the device requesting to join the meeting. For example, meeting client detection code may be activated (e.g., in response to a validated request) that detects meeting clients on the device. At 306, identifying the one or more meeting clients can comprise identifying parameters of the client. In one embodiment, one or more capabilities of the respective the meeting clients can be identified, such as types of meetings, locations, operational parameters (supported by respective clients), etc. In one embodiment, version information of the meeting client can be identified, such as which version (e.g., is it an older or a new version) of the meeting client does the device comprise.

At 308, the parameters of the respective one or more meeting clients can be compared to parameters for the meeting to determine if an identified meeting client comprises a supported meeting client (e.g., can be used to join the meeting, and/or comprises a desired configuration). If at least one of the one or more identified meeting clients comprises a supported meeting client (YES at 308), the supported meeting client can be selected. In one embodiment, more than one identified meeting client may comprise a supported meeting client. In this embodiment, the respective supported meeting clients can be prioritized, for example, based on meeting criteria, default preferences, and/or user preferences, etc. Further, for example, a supported meeting client comprising a highest prioritization may be selected.

At 312, the selected, supported meeting client can be launched on the device, and directed to the meeting coordinates for joining/activating the meeting. If no supported meeting clients are identified on the device (NO at 308) the device can be directed to an online-based meeting client, at 314. At 316, the device's browser can be launched and directed to the meeting coordinates using the online-based meeting client. At 318, the device can be connected to the meeting, for example, using the supported meeting client on the device, or the online-based meeting client.

In one embodiment, an option to download a supported meeting client may be provided, for example, if a supported meeting client is not selected (e.g., a meeting client is not present, and/or a supported meeting is not found). In this embodiment, for example, when a supported meeting client is not selected the device may be directed to a website whereby an option to download a supported meeting client is provided. Further, in this example, the user may be prompted to download the supported meeting client to provide a richer user experience for the meeting than may be provided by the online-based meeting client (e.g., richer, more robust, feature intensive, etc. than can be offered through a web-browser based application, for example).

In another embodiment, one or more telephone coordinates (e.g., a telephone number and/or meeting reference number) may be provided, for example, so that a user can call in to join and participate in the meeting. For example, a supported meeting client (e.g., an appropriate application for participating in the meeting) may not be available for download and/or be installed on the device. Further, in this example, the default or available browser for the device may not support joining the meeting. If a supported meeting client and/or online-based meeting client cannot be utilized, for example, the user can be provided an appropriate telephone number to call into the meeting (e.g., and a reference number to join the meeting).

As an illustrative example, client detection, selection, and/or launch on the device can be handled by using Active-X controls and/or browser plug-ins that may be installed on the device as part of corresponding meeting client installation. In this example, the Active-X Controls and/or browser plug-ins typically have a well defined interface that can be accessed by the code in the device code package (e.g., Java-Script). Further, in this example, the necessary controls and/or plug-ins of the different clients can be instantiated, and queried for the various client information through the well defined interface. In this way, for example, the meeting client (e.g., application) having the desired parameters for the meeting can be selected and launched.

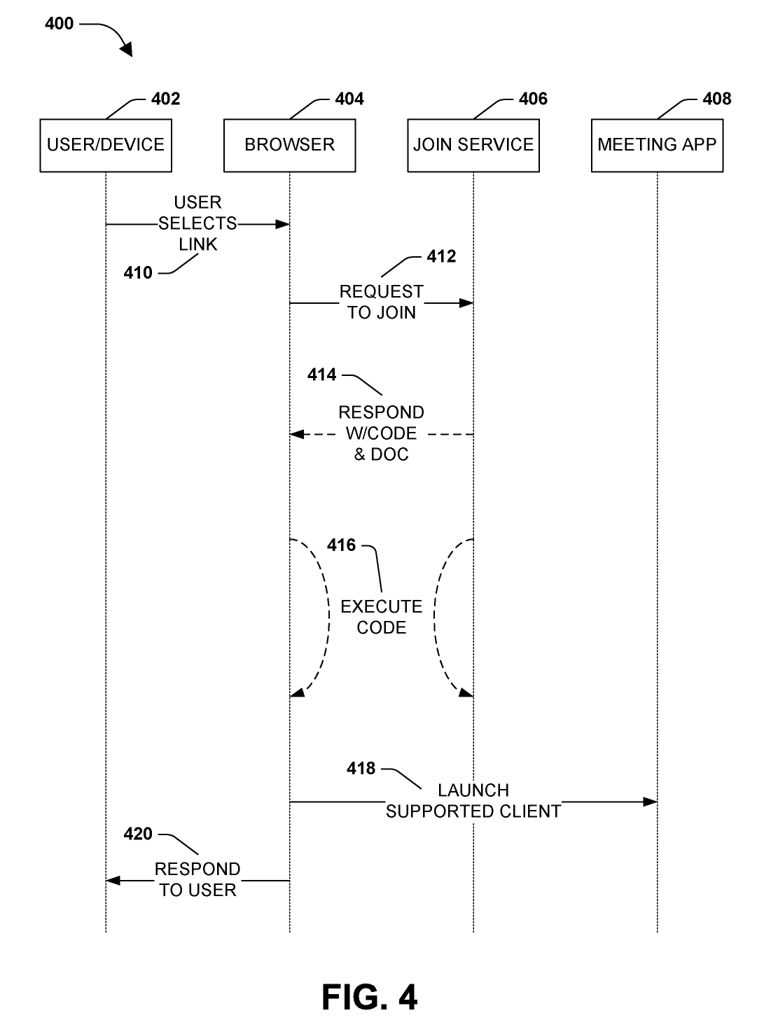

In one embodiment, the client detection, supported meeting client selection, the launching of the supported meeting client, and/or the directing of the device to an online meeting client may be performed by the join manager service, by the device, and/or by a combination of the join manager service and the device. As an illustrative example, FIG. 4 is a diagram illustrating an example embodiment 400 where one or more portions of one or more techniques described herein may be implemented. In the example embodiment 400, a user's device 402 can comprise a browser, which may connect to a join manager service 406 to join the meeting using a meeting client 408 (e.g., application).

At 410, the user 402 selects a link in a meeting invitation on their device 402. When the link is selected, the browser 404 can be launched, and sends a request to join the meeting, at 412. The join manager service 406 can receive the request 412 and, in one embodiment, may respond with the device code package and document comprising the information needed to join the meeting at 414. In one embodiment, the response at 414 may comprise the respective code used to detect, select, and launch the supported meeting client.

In another embodiment, the response at 414 may comprise portions of the code used to detect, select, and launch the supported meeting client, for example, where some of the detecting, selecting, and launching is performed on the device, at 416, and some is performed by the join manager service 406, at 416. In another embodiment, all of the detecting, selecting, and launching of the supported meeting client may be performed by the join manager service 406, at 416.

After the supported meeting client is selected, or an online meeting client is selected, the supported meeting client 408 (e.g., or online meeting client) is launched, at 418. In one embodiment, when the meeting client is launched, the user can be notified, at 420. Further, when the meeting client is launched and the user is notified, for example, the user's device 402 may connect to the online meeting using the meeting client 408.

Another method may be devised for joining a user of a device to an online meeting. Where the user's device may comprise one or more meeting clients (e.g., or no meeting client at all) that can join the device to a meeting, a supported (e.g., preferred, and/or properly configured) meeting client can be selected. The selected, supported meeting client may be launched on the device, for example, or an online-based meeting client may be initiated if no supported client is identified. Once launched, the user's device can be connected to the online meeting, for example, where the meeting client used may provide a preferred user experience (e.g., or allow the device to connect to the meeting).

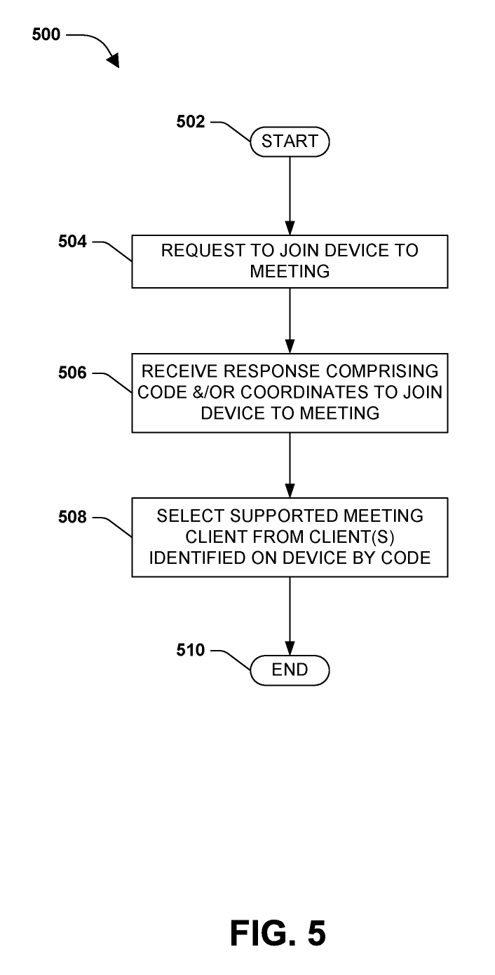

FIG. 5 is a flow diagram illustrating another exemplary method 500 for joining a device to a meeting. The exemplary method 500 begins at 502 and involves requesting to join the device to the meeting, where the request is made by using a meeting request link received by the device, at 504. For example, requesting to join the device to the meeting can comprise the device sending a request to join the meeting when a user selects a “join meeting” link in a message received at the device. Sending the request can comprise automatically sending the request to join the meeting from the device to a join meeting service when the link is selected (e.g., clicked on) by the user, for example.

At 506, a response to the request to join the meeting is received, where the response comprises code that is configured to join the device to the meeting. For example, in response to receiving the meeting request from the device, the join meeting service may send the response with the code to the device so that the device is able to join the meeting. In one embodiment, the response (e.g., code package comprised therein) may merely comprise online meeting coordinates for joining the meeting. In this embodiment, for example, the code may be comprised on the device, such as installed with one or more of the meeting clients. In this embodiment, as an example, the code installed on the device can operate on the online meeting coordinates comprised in the response to join the meeting, such that merely the coordinates are needed for the device to join the meeting.

At 508, the code is used to select a supported meeting client for joining the device to the meeting from one or more meeting clients identified on the device, if at least one meeting client is identified on the device. For example, the device may comprise one or more client applications that can be used to join and/or participate in the meeting. In this example, the one or more clients can be identified, using the code, and a desired (e.g., preferred) client can be selected as a supported meeting client for joining the device to the meeting.

Having selected the supporting meeting client to join the device to the meeting, the exemplary method 500 ends at 508.

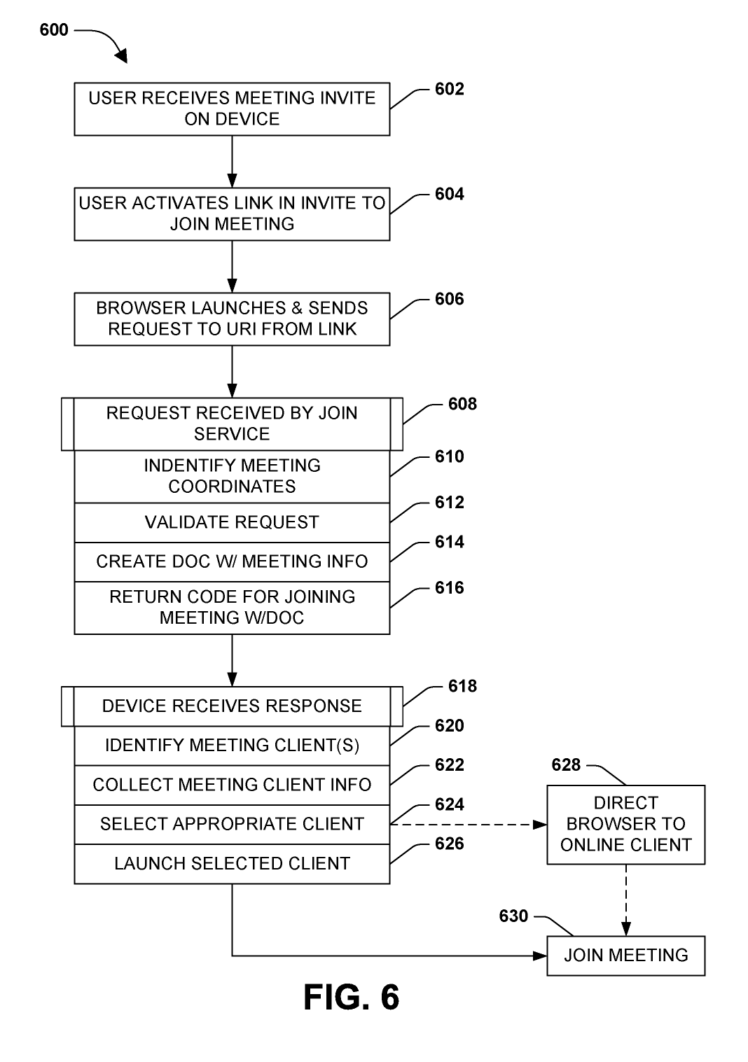

FIG. 6 is a flow diagram illustrating an example embodiment 600 where one or more portions of one or more techniques described herein may be implemented. At 602, a user receives an invitation to join an online meeting on a device. For example, the user may receive and email, instant message, or other electronic communication that comprises information about the meeting and a link that can join the device to the meeting. At 604, the user can activate the link (e.g., selecting the link by “clicking” on it) for joining the meeting.

At 606, in one embodiment, activating the link can automatically (e.g., programmatically) launch a browser on the device, which can send a request to join the meeting to a Universal Resource Identifier (URI), such as a Universal Resource Locator (URL) indicated by the link. For example, the link can comprise a URL that points to a location on the Internet for joining and/or participating in the online meeting. Further, when the URL is selected, the device may be configured to automatically launch the browser to navigate to the selected URL.

In one embodiment, another application (e.g., a mail and/or calendar application) on the device may be launched (e.g., or may already be running), and this application can may send the request to the join manager, for example, without activating a browser. As an example, the user may have opened their email application on the device to retrieve and read emails. In this example, the email application retrieves the invitation to join an online meeting, and the user accepts, activates, etc. the invitation to join the meeting (e.g., via email). Further, upon selection of the link, the email application can send the join meeting request to the join manager service, which may provide a more seamless join experience for the user.

At 608, a join service (e.g., join meeting manager service) server can receive the join meeting request sent by the browser on the device. For example, the join service may be configured to receive meeting requests sent by the device, in order to provide an enhanced user experience by handling incoming meeting requests. At 610, the join service can identify meeting coordinates (e.g., an online location for joining and/or participating in the meeting) from the URI in the link selected by the user. The request may be validated at 612, such as by determining that the requesting device is in fact authorized to join the meeting, for example. A document (e.g., an XML document) comprising meeting related information, such as the meeting coordinates, security information, etc. can be created, at 614.

At 616, code (e.g., script code, such as JavaScript) can be returned to the device from the join service, along with the created meeting document. In one embodiment, the code can be used to help join the device with the meeting. In one embodiment, the code can comprise logic that: identifies one or more meeting clients on the device; determines whether an identified meeting client is configured to support the meeting and the device (e.g., has an appropriate configuration, language, version, operating system match, etc.); prioritize respective identified meeting clients based at least upon a type of meeting associated with the request (e.g., whether an online meeting is configured to operate in a more desired manner with a particular client application as compared to other (versions of) client applications); prioritize respective identified meeting clients based at least upon an administrative policy (e.g., for the device, an enterprise, meeting preference, etc.); and/or prioritize respective identified meeting clients based at least upon a user preference (e.g., using a preferred client application). It may be appreciated that the code may facilitate any one or more or the foregoing, such as by working with additional, applications, programming, code, etc. on the device, for example.

At 618, the device can receive the response, such as from the join service that received the join meeting request. At 620, upon receiving the response comprising the code and meeting document, the code may be used to identify one or more meeting clients (e.g., applications used to join and/or participate in the online meeting) resident on the device. As an example, meeting applications can be installed on a user's device, and, during installation, controls and plug-ins are often installed that can help identify the meeting application. In this example, an interface for the one or more controls and plug-ins may be used by the code to identify the one or more meeting clients on the device. As another example, the browser may natively provide an ability to detect and launch an appropriate client application without installation of a browser plugin (e.g. through custom protocol handlers).

At 622, selection criteria can be identified and/or collected for the one or more identified meeting clients by querying the respective one or more meeting clients for desired selection criteria, using at least a portion of the received code. For example, selection criteria for a meeting client may comprise a version of the installed client (e.g., version number, string or identifier), existence of a browser plug-in for the client, one or more protocols for the client, and/or other relevant information.

At 624, the identified selection criteria can be used to select a supported meeting client, if present, based at least upon operational parameters for the meeting (e.g., necessary version of client, language, OS, supported plug-ins, browser support, etc.). In one embodiment, the supported meeting client can be selected (e.g., by using the code) from the one or more identified meeting clients based at least upon a configuration of the device. In this embodiment, for example, selecting the supported meeting client can be based on whether the code is enabled for the device (e.g., can the device read the code script, and/or document); whether a browser resident on the device supports joining the meeting; and/or whether one or more desired applications (e.g., required to work in conjunction) are installed on the device.

In one embodiment, if a supported meeting client is not identified, and/or selected, the browser on the device (e.g., the default browser) can be directed to an online meeting client, at 628, which may be used to join and participate in the meeting, at 630. For example, the device may not comprise any meeting clients, or may not comprise a supported meeting client (e.g., no meeting clients that can be used for joining/participating in the meeting). In this example, the device can be directed to an online version of the meeting, such as using the meeting coordinates, where the user may join and participate in the meeting.

At 626, if a supported meeting client is selected (e.g., from the one or more meeting clients on the device), the selected, supported meeting client is launched. Once the supported meeting client is launched, the device can be joined to the meeting, at 630. In one embodiment, joining the device to the meeting can comprise launching the supported meeting client on the device (e.g., using the code from the response), and directing the launched meeting client to the meeting coordinates received in the response (e.g., in the meeting document). For example, the launched, supported meeting client may be able to navigate to the meeting coordinates, and join the meeting using the meeting information provided in the meeting document.

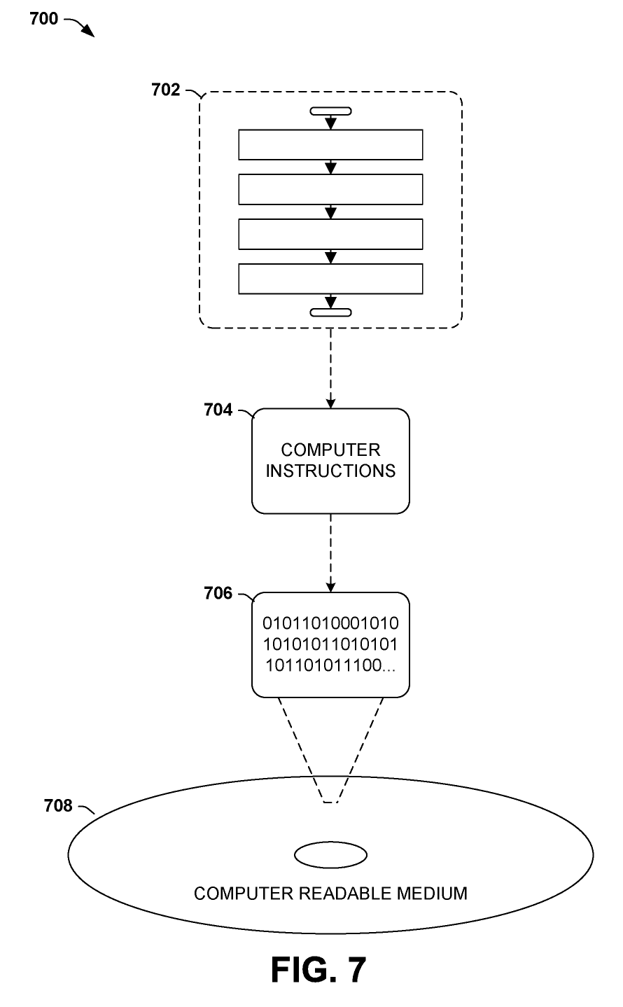

Still another embodiment involves a computer-readable medium comprising processor-executable instructions configured to implement one or more of the techniques presented herein. An exemplary computer-readable medium that may be devised in these ways is illustrated in FIG. 7, wherein the implementation 700 comprises a computer-readable medium 708 (e.g., a CD-R, DVD-R, or a platter of a hard disk drive), on which is encoded computer-readable data 706. This computer-readable data 706 in turn comprises a set of computer instructions 704 configured to operate according to one or more of the principles set forth herein. In one such embodiment 702, the processor-executable instructions 704 may be configured to perform a method, such as at least some of the exemplary method 100 of FIG. 1, for example, and/or method 500 of FIG. 5. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

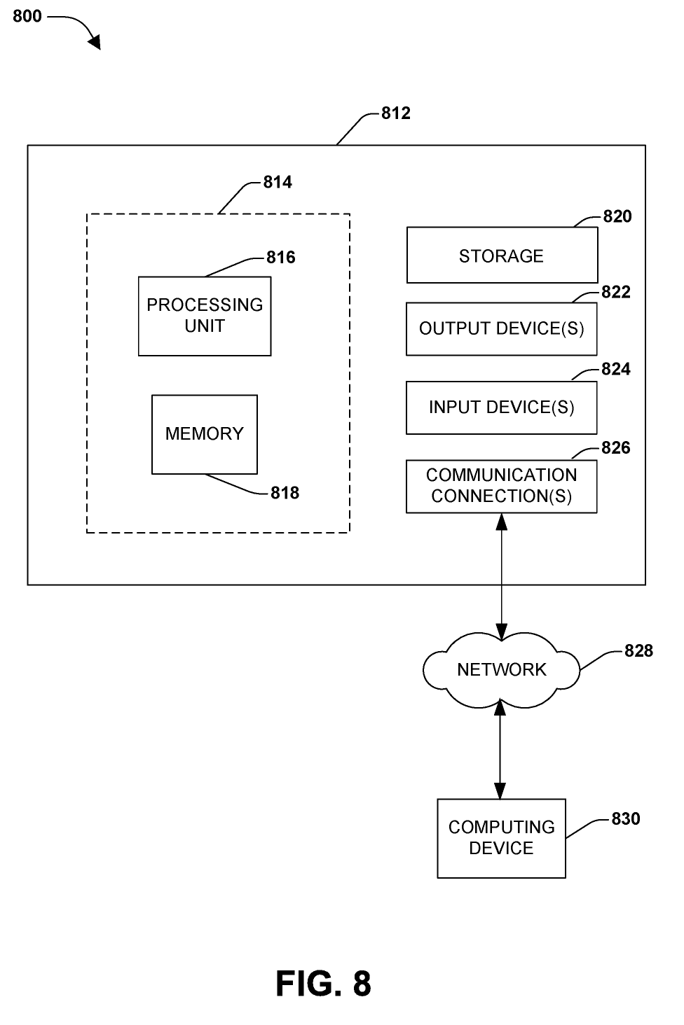

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 800 comprising a computing device 812 configured to implement one or more embodiments provided herein. In one configuration, computing device 812 includes at least one processing unit 816 and memory 818. Depending on the exact configuration and type of computing device, memory 818 may be volatile (such as RAM, for example), non-volatile (such as ROM, flash memory, etc., for example) or some combination of the two. This configuration is illustrated in FIG. 8 by dashed line 814.

In other embodiments, device 812 may include additional features and/or functionality. For example, device 812 may also include additional storage (e.g., removable and/or non-removable) including, but not limited to, magnetic storage, optical storage, and the like. Such additional storage is illustrated in FIG. 8 by storage 820. In one embodiment, computer readable instructions to implement one or more embodiments provided herein may be in storage 820. Storage 820 may also store other computer readable instructions to implement an operating system, an application program, and the like. Computer readable instructions may be loaded in memory 818 for execution by processing unit 816, for example.

The term “computer readable media” as used herein includes computer storage media. Computer storage media includes volatile and nonvolatile, removable and non-removable media implemented in any method or technology for storage of information such as computer readable instructions or other data. Memory 818 and storage 820 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 812. Any such computer storage media may be part of device 812.

Device 812 may also include communication connection(s) 826 that allows device 812 to communicate with other devices. Communication connection(s) 826 may include, but is not limited to, a modem, a Network Interface Card (NIC), an integrated network interface, a radio frequency transmitter/receiver, an infrared port, a USB connection, or other interfaces for connecting computing device 812 to other computing devices. Communication connection(s) 826 may include a wired connection or a wireless connection. Communication connection(s) 826 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 812 may include input device(s) 824 such as keyboard, mouse, pen, voice input device, touch input device, infrared cameras, video input devices, and/or any other input device. Output device(s) 822 such as one or more displays, speakers, printers, and/or any other output device may also be included in device 812. Input device(s) 824 and output device(s) 822 may be connected to device 812 via a wired connection, wireless connection, or any combination thereof. In one embodiment, an input device or an output device from another computing device may be used as input device(s) 824 or output device(s) 822 for computing device 812.

Components of computing device 812 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 812 may be interconnected by a network. For example, memory 818 may be comprised of multiple physical memory units located in different physical locations interconnected by a network.

Those skilled in the art will realize that storage devices utilized to store computer readable instructions may be distributed across a network. For example, a computing device 830 accessible via network 828 may store computer readable instructions to implement one or more embodiments provided herein. Computing device 812 may access computing device 830 and download a part or all of the computer readable instructions for execution. Alternatively, computing device 812 may download pieces of the computer readable instructions, as needed, or some instructions may be executed at computing device 812 and some at computing device 830.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, At least one of A and B and/or the like generally means A or B or both A and B. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method performed by a computing device, the method comprising:
sending a request to join an online meeting;
identifying online meeting coordinates for the online meeting, the online meeting coordinates specifying an online location for the online meeting;
directing the computing device to the online meeting by launching and directing the meeting client on the computing device to the online meeting coordinates, if the meeting client is available via the computing device; and
directing the computing device to an online-based meeting client, if the meeting client is not available via the computing device, by launching and directing the online-based meeting client to the online meeting coordinates.

2. The method of claim 1, wherein sending the request to join the online meeting includes receiving a selection associated with the online meeting.

3. The method of claim 1, further comprising:
in response to sending the request to join the online meeting, receiving the online meeting coordinates from an online meeting service.

4. The method of claim 3, wherein the online meeting service specifies a desired software version of the meeting client.

5. The method of claim 3, wherein the online meeting service specifies one or more capabilities associated with one or more meeting clients.

6. The method of claim 5, wherein the one or more meeting clients are prioritized based on one or more of a meeting criterion, a default preference, or a user preference.

7. The method of claim 1, wherein the online-based meeting client is a web client accessed via a browser.

8. A computing device comprising:
one or more processing units; and
memory comprising instructions that, when executed by at least one of the one or more processing units, cause the one or more processing units to:
send a request to join an online meeting;
identify online meeting coordinates for the online meeting, the online meeting coordinates specifying an online location for the online meeting;
launch the meeting client on the computing device to access the online meeting at the online meeting coordinates, if the meeting client is available via the computing device; and
launch an online-based meeting client, if the meeting client is not available via the computing device, to access the online meeting at the online meeting coordinates.

9. The computing device of claim 8, wherein to send the request to join the online meeting includes receipt of a selection associated with the online meeting.

10. The computing device of claim 8, further comprising:
in response to sending the request to join the online meeting, receive online meeting coordinates from an online meeting service.

11. The computing device of claim 10, wherein the online meeting service specifies a desired software version of the meeting client.

12. The computing device of claim 10, wherein the online meeting service specifies one or more capabilities associated with one or more meeting clients.

13. The computing device of claim 12, wherein the one or more meeting clients are prioritized based on one or more of a meeting criterion, a default preference, or a user preference.

14. A method performed by a computing device, the method comprising:
sending a request to join an online meeting;
identifying online meeting coordinates for the online meeting, the online meeting coordinates specifying an online location for the online meeting;
receiving parameters that identify a supported meeting client;
detecting whether the supported meeting client is available via the computing device;
in response to detecting that the supported meeting client is available, launching the supported meeting client to access the online meeting at the online meeting coordinates; and
in response to detecting that the supported meeting client is unavailable, providing an option to download the supported meeting client.

15. The method of claim 14, wherein a website associated with the supported meeting client provides the option to download the supported meeting client.

16. The method of claim 14, further comprising providing one or more telephone coordinates to participate in the online meeting when the supported meeting client is unavailable.

17. The method of claim 14, wherein detecting whether the supported meeting client is available via the computing device is managed by Active-X controls.

18. The method of claim 14, wherein launching the supported meeting client to access the online meeting at the online meeting coordinates is managed by Active-X controls.

19. The method of claim 14, wherein receiving the parameters that identify the supported meeting client further comprise a version associated with the supported meeting client.

20. The method of claim 14, wherein the parameters identify one or more capabilities associated with the supported meeting client.
